(19) United States
(12) Patent Application Publication
(10) Pub. No.: US 2008/0193159 A1
(43) Pub. Date: Aug. 14, 2008

(54) IMAGE FORMING APPARATUS

(75) Inventors: Takuya Terae, Abiko-shi (JP); Akinori Tanaka, Abiko-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/023,529

(22) Filed: Jan. 31, 2008

(30) Foreign Application Priority Data
Feb. 13, 2007 (JP) 2007-031882

(51) Int. Cl. G03G 21/00

(52) U.S. Cl. 399/98

(57) ABSTRACT

An image forming apparatus includes: an image bearing member, on which an electrostatic image is formed; a development unit which is provided with a developer bearing member for bearing and conveying a developer, so as to develop the electrostatic image; a storage place which can store therein the developer spattering from the development unit; a shielding member which is disposed in a region outside of a development region in the storage place; and a foreign material collecting member which is disposed in a region farther outside of the shielding member in the storage place.

### BACKGROUND OF THE INVENTION

1. Field of the Invention

The present invention relates to an image forming apparatus such as a copying machine, a printer, a recorded image display apparatus or a facsimile which forms a visible image by an electrophotographic system.

2. Description of the Related Art

In a composite machine having copying and printing functions or a facsimile, there is widely prevailed at present an image forming apparatus of an electrophotographic system, in which a development unit develops a toner image on an image bearing member.

In such an image forming apparatus of an electrophotographic system, it is necessary to prevent the inside of the image forming apparatus from being smeared with a toner spattering from the development unit while effectively utilizing a space defined inside of the image forming apparatus in order to cope with miniaturization of the image forming apparatus.

There has been known a technique for preventing the inside of the image forming apparatus from being smeared with the toner spattering from the development unit, as disclosed in Japanese Patent Application Laid-open No. 11-084793.

In an image forming apparatus disclosed in Japanese Patent Application Laid-open No. 11-084793, a developer storing tray is housed in a space on a side opposite to an image bearing member in the development unit, and further, at a lower portion in a space above a fixing device. The toner spattering from the development unit is stored in the developer storing tray, thereby preventing the inside of the image forming apparatus from being smeared with the toner.

However, the technique disclosed in Japanese Patent Application Laid-open No. 11-084793 allows the toner spattering from the development unit to be stored in the developer storing tray, but permits also foreign materials other than the toner, spattering from members other than the development unit to be stored in the developer storing tray. Members other than the development unit such as a gear train, a development bias contact, an oscillation spring and an adjusting member mostly generate foreign materials (e.g., metallic powder). The foreign materials, in particular, the metallic powder generated from the aforementioned members are deposited on the developer storing tray, and then, the deposited foreign materials are carried to the development unit, thereby raising a possibility of a damage exerted on a development sleeve inside of the development unit or the image bearing member disposed opposite to the development sleeve.

### SUMMARY OF THE INVENTION

In view of the above-described problems, the present invention aims at preventing foreign materials, which are accidentally stored at the same time in a storage place for storing therein a toner spattering from a development unit, from being carried to the development unit, and then, from exerting a damage on a member inside of the development unit or an image bearing member disposed opposite to the member.

Accordingly, an image forming apparatus includes: an image bearing member, on which an electrostatic image is formed; a development unit which is provided with a developer bearing member rotatably disposed at a position opposite to the image bearing member, to bear and convey a developer, so as to develop the electrostatic image; a storage place which is located under the development unit and can store therein the developer spattering from the development unit; a shielding member which is disposed in a region outside of a development region of the developer bearing member in a direction of a rotary axis of the developer bearing member in the storage place; and a foreign material collecting member which is disposed in a region farther outside of the shielding member in the direction of the rotary axis of the developer bearing member in the storage place.

Further features of the present invention will become apparent from the following description of exemplary embodiments (with reference to the attached drawings).

### BRIEF DESCRIPTION OF THE DRAWINGS

FIG. 1 is a vertically cross-sectional view illustrating the schematic configuration of an image forming apparatus;

FIG. 2 is a perspective view illustrating the general configuration of a development rotor;

FIG. 3 is a perspective view illustrating the general configuration of a development device;

FIG. 4 is another perspective view illustrating the general configuration of the development device;

FIG. 5 is a perspective view explanatory of the particulars of a toner conveyor in the development rotor;

FIG. 6 is a perspective view explanatory of the particulars of a toner storage place in the development rotor; and

FIG. 7 is a view illustrating the toner storage place in a longitudinal direction.

### DESCRIPTION OF THE EMBODIMENTS

A detailed description will be illustratively given below of an embodiment according to the present invention in reference to the attached drawings. Here, the dimension, material, size and relative arrangement of constituent parts described in the embodiment, described below, may be appropriately varied according to the configuration or various kinds of conditions of an apparatus, to which the present invention is applied. As a consequence, the scope of the present invention is not limited only to those in the embodiment, unless otherwise stated.

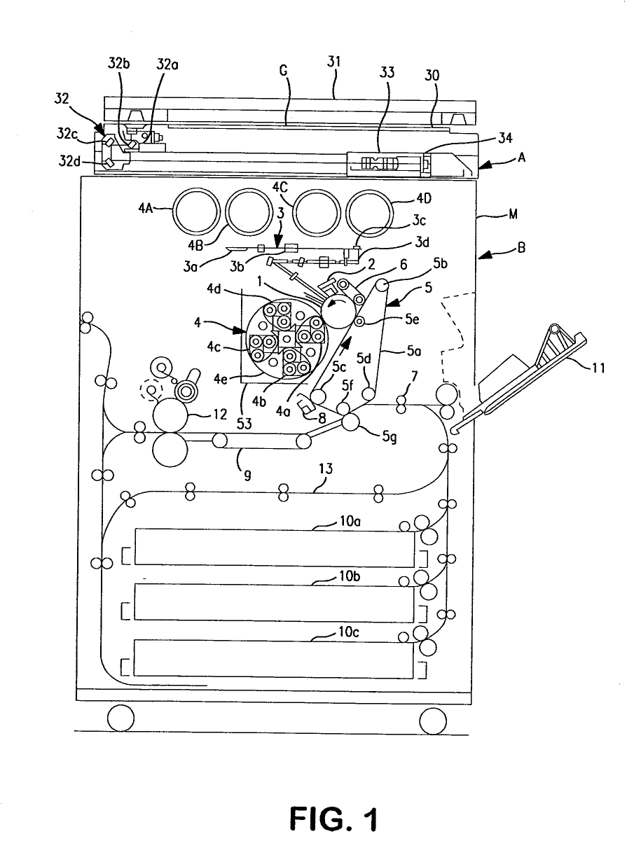

FIG. 1 is a vertically cross-sectional view illustrating the schematic configuration of an image forming apparatus. The image forming apparatus shown in FIG. 1 is of a full color type. The image forming apparatus is provided, at an upper portion thereof, with a digital color image reader unit A (hereinafter simply referred to as “a reader unit A”) which reads an image formed on an document G. Furthermore, the image forming apparatus is provided, at a lower portion thereof, with a digital color image printer unit B (hereinafter simply referred to as “a printer unit B”) which forms an image. The printer unit B includes a single photosensitive drum serving as an image bearing member, a rotary development unit serving as developing means, and an intermediate transfer belt serving as an intermediate transfer member. Explanation will be made below on each of the units A and B.

The reader unit A includes an document base plate glass 30, an document pressing plate 31, a scanner unit 32, a lens 33 and a CCD 34. Among these constituents, the scanner unit 32 has a light source 32a and a plurality of mirrors 32b, 32c and 32d, so that the scanner unit 32 as a whole is moved rightward in FIG. 1 from a home position shown in FIG. 1. The document G is placed on the document base plate glass 30 in such a manner that its surface having an image thereon is oriented downward. The document G is configured such that the image surface is scanned by the scanner unit 32 which is moved rightward in FIG. 1. In other words, the scanner unit 32 emits a light beam from the light source 32a so as to irradiate the image surface of the document G with the light beam while being moved rightward in FIG. 1. The resultant reflected light is further reflected on the mirrors 32b, 32c and 32d, and then, is input into the CCD 34 through the lens 33, to be converted into an electric signal. The electric signal is subjected to various kinds of image processing such as shading correction, color correction and density processing in an image processing portion, not shown, to be then input into an exposing device, described later.

The printer unit B includes a drum-shaped electrophotographic photosensitive member (hereinafter referred to as “a photosensitive drum”) 1 serving as an image bearing member. The photosensitive drum 1 is supported rotatably in a direction indicated by an arrow in an image forming apparatus main body (hereinafter referred to as “a main body”) M. Around the photosensitive drum 1 are disposed a primary charger (i.e., charging means) 2, the exposing device (i.e., exposing means) 3, a development unit (i.e., developing means) 4, a transferring device 5 and a cleaning device 6 substantially in order in the rotational direction of the photosensitive drum 1. Among these constituents, the primary charger 2 is adapted to uniformly charge the surface of the photosensitive drum 1 with a predetermined polarity and at a predetermined potential. Furthermore, the exposing device 3 includes a laser emitter, not shown, a polygon mirror 3a, a lens 3b, reflection mirrors 3c and 3d and the like. An image read in the above-described reader unit A is converted into an optical signal of each of colors in the laser emitter. A laser light beam of a first color, converted into an optical signal, is reflected on the polygon mirror 3a, and then, exposes the charged surface of the photosensitive drum 1 through the lens 3b, the reflection mirrors 3c and 3d and the like. In this manner, an electrostatic image of the first color is formed on the photosensitive drum 1.

The development unit 4 includes a rotatable development rotor (i.e., a rotating member) 4e and four development devices (for four colors) mounted on the development rotor 4e, that is, a development device 4a for yellow (Y), a development device 4b for magenta (M), a development device 4c for cyan (C) and a development device 4d for black (BK). In the development unit 4, the development device for a color to be developed is located at a development position facing to the photosensitive drum 1 according to the rotation of the development rotor 4e, and thereafter, a toner stored in a developer adheres onto the electrostatic image formed on the photosensitive drum 1, thereby developing a toner image. Incidentally, the development unit 4 will be explained later in detail.

The transferring device 5 includes an intermediate transfer belt 5a serving as an intermediate transfer member stretched across a plurality of rollers. The plurality of rollers are a drive roller 5b, a driven roller 5c, a tension roller 5d, a primary transfer roller 5e, a secondary transfer counter roller 5f and a secondary transfer roller 5g. The above-described toner image formed on the photosensitive drum 1 is (primarily) transferred onto the intermediate transfer belt 5a by the primary transfer roller 5e.

The toner (i.e., a residual toner) remaining on the photosensitive drum 1 having the toner image primarily transferred thereonto is removed by the cleaning device 6, followed by image formation with a next color.

The above-described series of image forming processes including the primary charging, the exposure, the development, the primary transfer and the cleaning is repeated with respect to the other three colors. As a result, the toner images of the four colors are superimposed one on another on the intermediate transfer belt 5a.

These toner images of the four colors formed on the intermediate transfer belt 5a are (secondarily) transferred at one time onto a recording material to be conveyed between the intermediate transfer belt 5a and the secondary transfer roller 5g. The recording material is supplied from a sheet cassette 10a, 10b or 10c or a manual tray 11, to be conveyed to a registration roller 7 via a sheet roller, a conveying roller or the like, in which skew feeding is corrected and the conveyance is temporarily stopped. The recording material is supplied between the intermediate transfer belt 5a and the secondary transfer roller 5g by the registration roller 7 while providing timing for the toner image formed on the intermediate transfer belt 5a. In this manner, the toner images of the four colors formed on the intermediate transfer belt 5a are transferred onto the recording material at one time. The toner (i.e., a residual toner) remaining at the surface of the intermediate transfer belt 5a after the toner images are transferred is removed by a belt cleaner 8, followed by next transferring.

In the meantime, the recording material after the transfer of the toner images is conveyed to a fixing device 12 by a conveyance belt 9. In the fixing device 12, the toner image is fixed onto the recording material by heating and pressurizing, thus completing the image formation on either surface of the recording material. Here, in the case of duplex image formation, the recording material having the toner image fixed thereonto is reversed, and then, is conveyed onto a re-feed path 13, from which the recording material is fed again toward the secondary transfer roller 5g.

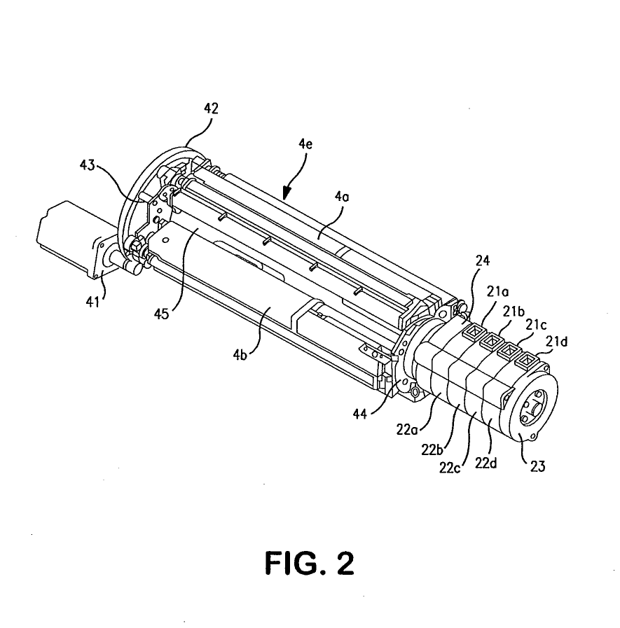

FIG. 2 is a perspective view illustrating the development rotor 4e having the above-described four development devices (only the development devices 4a and 4b are shown in FIG. 2) mounted thereon and respective toner receivers (i.e., toner replenishing ports) 21a, 21b, 21c and 21d for the development devices, as viewed from the top.

The development rotor 4e includes a rear plate unit 43, a fore plate unit 44 and a rotary stay (i.e., a connecting stay unit) 45 for connecting the units 43 and 44 to each other, and is supported at flanges, not shown, formed at fore and rear plates by the main body M via bearings.

A drive gear 42 integrated with the rear plate unit 43 is rotatably driven by a rotary drive motor 41 disposed in the main body M, so as to switch the development devices 4a, 4b, 4c and 4d. The rotary drive motor 41 is a stepping motor since the development devices 4a, 4b, 4c and 4d need be speedily switched at a rotational angle with a secure accuracy.

Before the development rotor 4e is arranged a toner receiving unit, which is provided with fixing flanges 22a, 22b, 22c and 22d having the toner receivers 21a, 21b, 21c and 21d, respectively, a flange supporting mount 24, and a flange cover 23. The toner receiving unit is fixingly housed at the fore portion in the main body M, so that the toner receivers 21a, 21b, 21c and 21d receive the toners of the colors supplied from toner cartridges (i.e., toner supplying means) 4A, 4B, 4C and 4D (see FIG. 1). Thereafter, the toner received in the toner receiving unit is delivered down to the toner conveying means inside of the development rotor 4e.

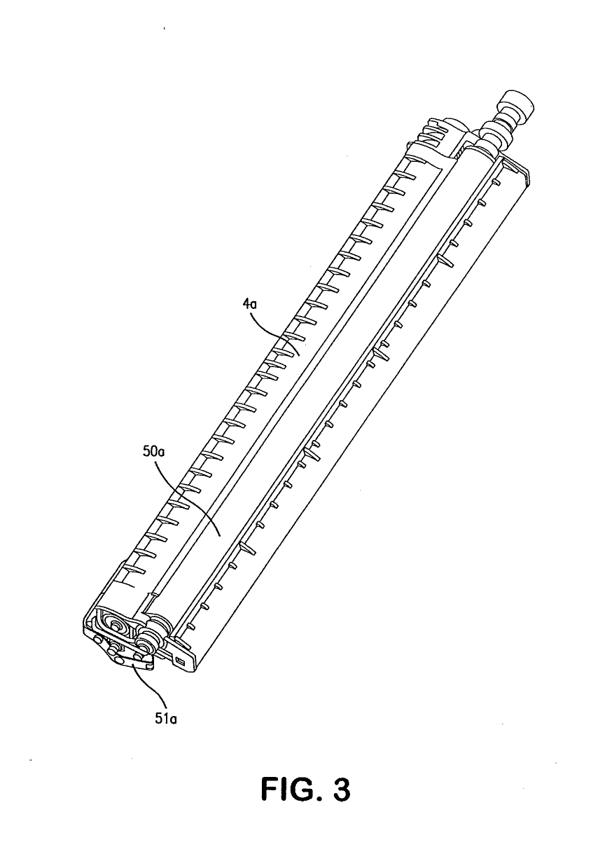

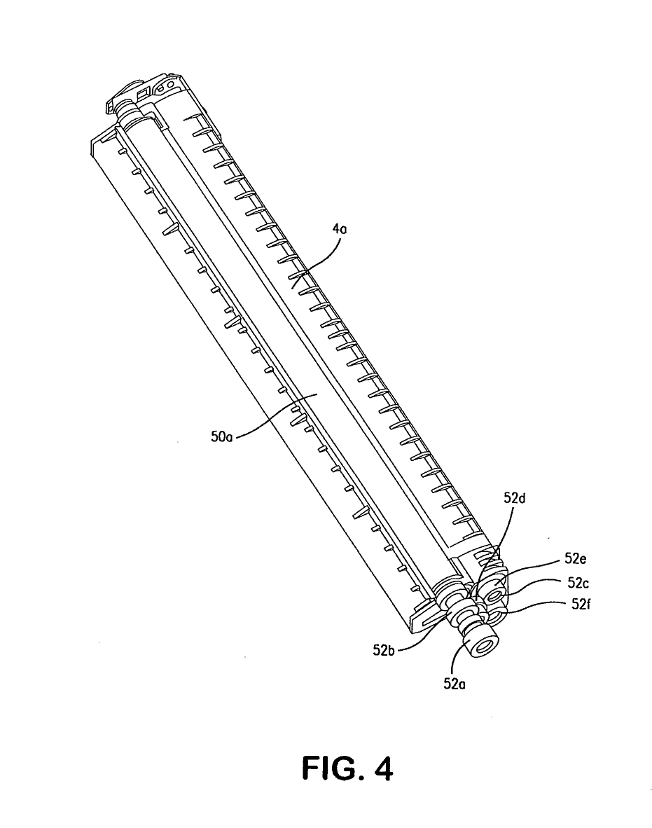

FIGS. 3 and 4 are perspective views illustrating the development device, as viewed from the bottom. FIG. 3 is a perspective view illustrating the development device, as viewed from a bias contact; and FIG. 4 is a perspective view illustrating the development device, as viewed from the drive gear. Here, since the development devices 4a, 4b, 4c and 4d have the same configuration, the development device 4a is typically illustrated in FIGS. 3 and 4.

The development device 4a includes, at a fore portion thereof, a development bias contact 51a serving as a high voltage contact for a development sleeve 50a. The development bias contact 51a is designed to be brought into contact with a contact of only a color to be developed, not shown, disposed at the fore plate of the development unit 4 during the development. As a consequence, the development bias contact 51a is brought into slidable contact with the contact, not shown, disposed at the fore plate of the development unit 4 in switching the development devices 4a, 4b, 4c and 4d, metallic powder is generated due to the abrasion of the contact.

Moreover, the development device 4a includes, at a rear portion thereof, a development drive gear 52a serving as a gear for driving the development sleeve 50a, and other development drive gears 52b, 52c, 52d, 52e and 52f serving as gears for driving a toner conveying screw, not shown. The development drive gear 52a is designed to rotatably drive the development drive motor for only the color to be developed, not shown, disposed in the main body M during the development. The rotational drive of the development drive gear 52a rotates the development drive gears 52b, 52c, 52d, 52e and 52f, thereby rotatably driving the toner conveying screw, not shown. Consequently, the development drive gears 52b, 52c, 52d, 52e and 52f are brought into slidable contact with each other during the rotational drive of the development drive gear 52a, thereby generating foreign materials such as swarf of a resin due to the abrasion of the gear.

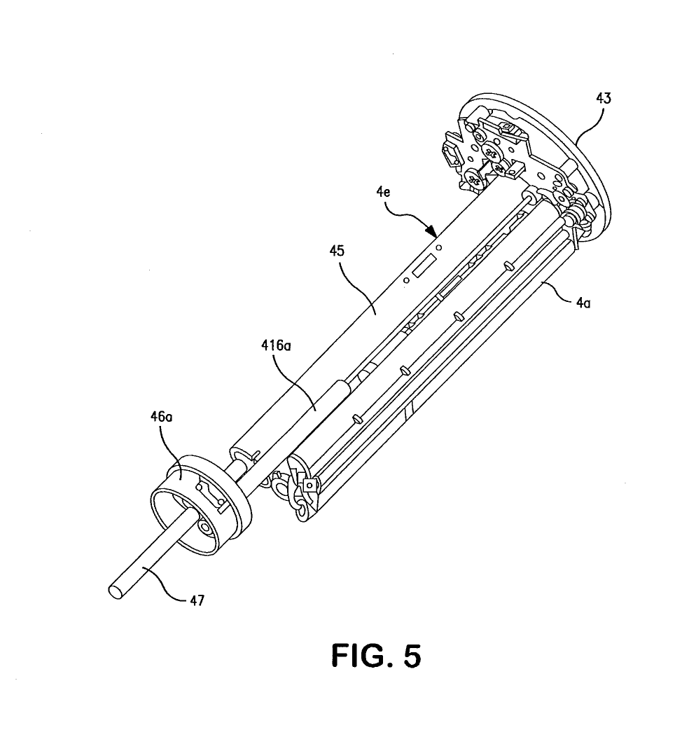

FIG. 5 is a perspective view partly illustrating the toner conveying means inside of the development rotor 4e. As shown in FIG. 5, the toner conveying means includes a cylindrical rotary drum (i.e., a first cylindrical rotor) 46a and a toner conveyor 416a containing therein the toner conveying screw for conveying the toner to the development device 4a. In FIG. 5, the development devices 4b, 4c and 4d, cylindrical rotary drums 46b, 46c and 46d and toner conveyors 416b, 416c and 416d for the other colors are omitted.

The toner conveyed from the toner cartridge 4A is conveyed to the toner receiver 21a shown in FIG. 2, and then, is supplied down to the rotary drum 46a whose opening faces right above owing to the rotation of the development rotor 4e.

The toner conveyor 416a is housed inside of the cylinder of the rotary drum 46a in order to convey the falling toner to the development device 4a. The rotary drum 46a is configured such that its opening faces right above when the development device 4a is located at the development position (i.e., an image formation position) owing to the rotation of the development rotor 4e, and thus, the toner of only the color to be developed can be supplied during the development.

The rotary stay 45 structurally serves as a rotary axis of the development rotor 4e. An extension axis 47 is combined coaxially with the rotary stay 45 toward the rotary drum from the rotary stay 45, to be fitted to and positioned at a center hole of the rotary drum 46a. In this manner, the rotary drum 46a is configured in such a manner as to be rotated with a secure accuracy of a coaxial degree with respect to the rotary stay 45 of the development rotor 4e during the rotation of the development rotor 4e.

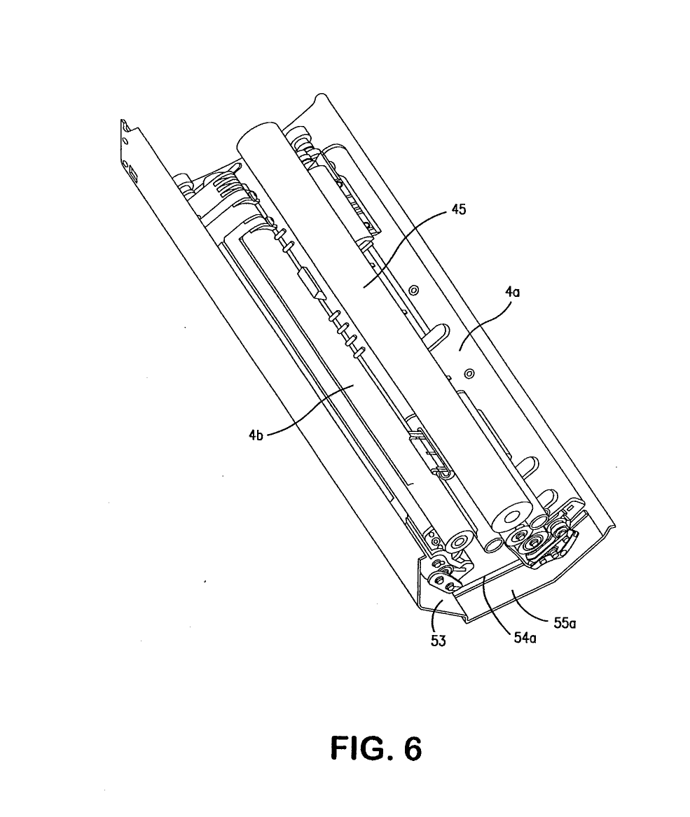

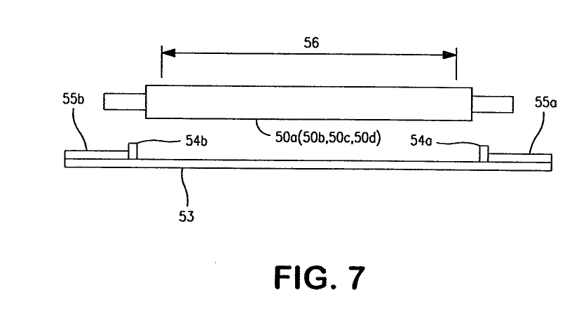

FIG. 6 is a perspective view partly illustrating a toner storing member inside of the development rotor 4e; and FIG. 7 is a view illustrating the longitudinal relationship between the toner storing member and the development sleeve in the development device. As shown in FIGS. 6 and 7, the toner storing member 53 is storing means (i.e., a storage place) for storing therein the toner spattering from a development region 56, in which the photosensitive drum and the development device (i.e., the development sleeve) face each other. The toner storing member 53 includes shielding members (i.e., shielding means) 54a and 54b for shielding the boundaries between the development region 56 and non-development regions other than the development region. The shielding members 54a and 54b are disposed on both sides of the boundaries between the development region 56 and the non-development regions. Moreover, the toner storing member 53 includes collecting members (i.e., collecting means) 55a and 55b for collecting the foreign materials spattering from the outside of the development region. The collecting members 55a and 55b are disposed in both of the non-development regions shielded by the shielding members 54a and 54b, respectively. That is to say, the shielding members 54a and 54b and the collecting members 55a and 55b are disposed backward and forward of the development unit 4, respectively.

The toner storing member 53 structurally also serves as a stay for the development unit 4 and for the purpose of cost reduction owing to the reduction of the number of component parts. Therefore, the toner storing member 53 is arranged in such a manner as to cover the development rotor 4e in the rotational direction within a range in which the development devices 4a, 4b, 4c and 4d are switched without any interference in order to cope with the miniaturization of the image forming apparatus (see FIG. 1).

The shielding members 54a and 54b are the shielding means for shielding the development region 56, in which the photosensitive drum 1 and the development unit (i.e., the development device located at the development position) 4 face each other, from the non-development regions other than the development region 56. The shielding members 54a and 54b are mounted on the storing member 53 in such a manner as to shield the development region 56 from the non-development regions. More particularly, the shielding members 54a and 54b are disposed on both sides of the boundaries between the development region 56 and the non-development regions (i.e., backward and forward of the development unit 4), respectively. The development region signifies a region in which the development sleeve 50a and the photosensitive drum 1 face each other, and further, a region which is shielded by the shielding members 54a and 54b mounted on the storing member 53. The non-development region signifies a region other than the development region.

The collecting members 55a and 55b are the collecting means for collecting the foreign materials spattering from the outside of the development unit 4. The collecting members 55a and 55b are disposed in the non-development regions on the storing member 53, that is, in both of the non-development regions shielded by the shielding members 54a and 54b (i.e., backward and forward of the development unit 4), respectively.

Each of the shielding members 54a and 54b is constituted of a foamable member. In contrast, each of the collecting members 55a and 55b is constituted of a viscous member. The reason why the shielding member is constituted of the foamable member is that the shielding member functions as a more favorable wall which can collect the toner in addition to the function of a shielding wall if foreign materials intrude into or clog a foamable unit. The reason why the collecting member is constituted of the viscous member is that a collecting function can be efficiently achieved in a saved space (i.e., in thinness) and at a reduced cost.

Additionally, the shielding members 54a and 54b and the collecting members 55a and 55b are constituted of the same member. The reason why the same member is used is that the same member is more favorably used from the viewpoint of a fabrication cost and the like since the above-described members are disposed backward and forward of the development unit 4 simply for the same purpose with the same function.

In the above-described embodiment, the toner spattering from the development region 56 is stored in the development region 56 shielded by the shielding members 54a and 54b in the storing member 53. As a consequence, the inside of the image forming apparatus can be prevented from being smeared with the toner spattering from the development region 56. Furthermore, the foreign materials such as the metallic powder or the swarf of the resin spattering from other than the development region can be shielded by the shielding members 54a and 54b from intruding into the development region 56. Moreover, the foreign materials can be collected by the collecting members 55a and 55b disposed in the non-development regions shielded by the shielding members 54a and 54b in the storing member 53. Consequently, the foreign materials spattering from other than the development region can be prevented from being carried to the development unit, and further, from exerting a damage on the member (i.e., the development sleeve) inside of the development unit or the photosensitive drum facing the member.

Although the image forming apparatus is exemplified by the copying machine in the above-described embodiment, the present invention is not limited to this. For example, the present invention may be applied to other image forming apparatuses such as a printer, a facsimile and a composite machine having the combination of the functions of the printer and the facsimile. The same effects can be produced by applying the present invention to the above-described image forming apparatuses.

Otherwise, although the image forming apparatus includes the four development devices in the above-described embodiment, the number of development devices is not limited to four. The number of development devices can be appropriately set, as necessary. The present invention is effective irrespective of the number of development devices. Alternatively, although the plurality of development devices can be rotatably switched in the image forming apparatus, the present invention is not limited to this.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-31882, filed Feb. 13, 2007, which is hereby incorporated by reference herein in its entirety.

What is claimed is:

1. An image forming apparatus comprising:
an image bearing member, on which an electrostatic image is formed;
a development unit which is provided with a developer bearing member rotatably disposed at a position opposite to the image bearing member, to bear and convey a developer, so as to develop the electrostatic image;
a storage place which is located under the development unit and can store therein the developer spattering from the development unit;
a shielding member which is disposed in a region outside of a development region of the developer bearing member in a direction of a rotary axis of the developer bearing member in the storage place; and
a foreign material collecting member which is disposed in a region farther outside of the shielding member in the direction of the rotary axis of the developer bearing member in the storage place.

2. An image forming apparatus according to claim 1, wherein the shielding members are disposed on both sides, respectively, outside of the development region of the developer bearing member in the direction of the rotary axis of the developer bearing member in the storage place; and
the foreign material collecting members are disposed in the regions, respectively, farther outside of the shielding members in the direction of the rotary axis of the developer bearing member in the storage place.

3. An image forming apparatus according to claim 1, wherein the shielding member and the foreign material collecting member are constituted of the same member.

4. An image forming apparatus according to claim 1, wherein the shielding member is constituted of a foamable member whereas the foreign material collecting member is constituted of a viscous member.

5. An image forming apparatus according to claim 1, wherein the development unit includes development devices, each having the developer bearing member, and a rotor which holds the development device therein so as to rotatably move the development device.
